(19) United States
(12) Patent Application Publication
(10) Pub. No.: US 2024/0253996 A1
(43) Pub. Date: Aug. 1, 2024

(54) APPARATUS AND METHOD FOR PRODUCING SILICON BY CARBOREDUCTION

(71) Applicant: HPQ Silicium Inc., Montreal (CA)

(72) Inventors: Jed KRAIEM, Lyon (FR); Oleksiy NICHIPORUK, MIONS (FR); Julien DEGOULANGE, Saint Genis Laval (FR)

(21) Appl. No.: 18/424,087

(22) Filed: Jan. 26, 2024

(30) Foreign Application Priority Data
Jan. 27, 2023 (FR) FR2300779

(51) Int. Cl. C01B 33/025; B01J 8/02

(52) U.S. Cl. CPC C01B 33/025; B01J 8/0278; B01J 8/0285; B01J 2208/00398

(57) ABSTRACT

An apparatus for producing silicon from quartz, the apparatus comprising: a sealed enclosure defining an enclosed space in which a depression can be generated, an electric arc furnace housed inside the enclosure and including a tank for containing a mixture of reagents, remarkable in that the apparatus further comprises a lid housed in the enclosure and adapted to cover an upper opening of the tank.

### FIELD OF THE INVENTION

The present invention relates to the general technical field of producing silicon from quartz.

In particular, the invention relates to a device for producing silicon by carboreduction of quartz in an electric arc furnace.

### BACKGROUND OF THE INVENTION

The production of silicon metal is generally based on the carbothermic reduction of quartz at high temperature and atmospheric pressure.

This carbothermic reduction of quartz can be achieved by chemically reducing quartz in the presence of carbon-based reducing agents in an electric arc furnace where a high temperature arc heats the reactants (quartz and reducing agents).

This allows to produce silicon called “metallurgical grade” silicon (or “MG-Si” acronym for the expression “Metallurgical grade silicon”) with a maximum purity of 98-99%.

Metallurgical grade silicon can be used:
as an alloying element—for example in the aluminum and steel industry—or
as a precursor—for example in the photovoltaic industry (solar panels), for silicones and for energy storage (Lithium batteries).

Technological developments in the fields of photovoltaics and energy storage have led metallurgical grade silicon to become a strategic material.

Therefore, sourcing high purity metallurgical grade silicon at a reasonable cost has become a necessity.

However, conventional metallurgical silicon production devices and processes have many disadvantages such as a high content of impurities.

To overcome this disadvantage, it is possible to use a raw material (quartz) having high purity. However, this solution increases the production cost of the metallurgical silicon produced.

Document U.S. Pat. No. 11,267,714 proposes another solution consisting of implementing the carbothermic reduction of quartz at high temperature under vacuum. Carrying out the carbothermic reduction of quartz under vacuum allows to promote the evaporation of impurities present in the reagents (quartz and reducing agents) as well as in the newly produced liquid metallurgical grade silicon.

With reference to FIG. 1, the apparatus according to U.S. Pat. No. 11,267,714 comprises an electric arc furnace FA and a sealed, closed enclosure E containing the arc furnace FA. This arrangement (sealed enclosure E containing the arc furnace FA) allows to control the pressure at which the carbothermic reduction of quartz is implemented.

However, the alternative embodiments of the apparatus described in U.S. Pat. No. 11,267,714 have certain limitations which make it difficult to use the solution according to U.S. Pat. No. 11,267,714 on an industrial scale:
a first limitation relates to the relatively low reaction rate of the reagents (quartz and reducing agents),
a second limitation relates to the amount of electrical energy necessary for the production of metallurgical grade silicon.

These two limitations (low reaction yield, high electricity consumption) make the solution described in U.S. Pat. No. 11,267,714 too expensive to be exploited industrially.

A purpose of the present invention is to propose an apparatus for producing silicon from quartz allowing to overcome at least one of the aforementioned disadvantages.

In particular, a purpose of the present invention is to propose one (or more) improvement(s) to the apparatus according to U.S. Pat. No. 11,267,714 to facilitate its use on an industrial scale.

### BRIEF DESCRIPTION OF THE INVENTION

To this end, the invention proposes an apparatus for producing silicon from quartz, the apparatus comprising:
a sealed enclosure defining an enclosed space, the enclosure being connected to at least one suction pump to generate a pressure difference between the interior and the exterior of the enclosed space, the pressure inside the enclosed space being lower than the pressure outside the enclosed space when the suction pump is activated,
an electric arc furnace housed inside the sealed enclosure, the arc furnace including:
   a tank for containing a mixture of raw materials for the production of silicon,
   a set of electrodes configured to form an electric arc for heating the mixture,
      remarkable in that the apparatus further comprises a movable lid housed in the enclosure, the lid being adapted to cover an upper opening of the tank.

Preferred but non-limiting aspects of the apparatus according to the invention are the following:
the lid may comprise a cover tray, and at least one support shaft fixed to the cover tray, the movable lid being able to be moved between:
   a closed position in which the cover tray completely covers the upper opening of the tank, and
   an open position in which the upper opening of the tank is at least partially uncovered;
the cover tray may comprise at least one through lumen and at least one associated shutter component, each shutter component being movable between:
   a released position in which the through lumen is unblocked to allow the circulation of a gas between:
      a first region defined between the tank and the cover tray, and
      a second region external to the first region,
   a shut position in which the through lumen is blocked to limit the circulation of gas between the first and second regions;
advantageously:
   each through lumen can be composed of a frustoconical vent provided in the cover tray, and
   each associated shutter element can be composed:
      of a plug of complementary shape to the frustoconical vent and
      of a suspension rod fixed to the plug to allow its movement in translation between the released and shut positions;
the cover tray may include:
   a plate including cylindrical perforations,
   a rotating puck configured to rest on the plate so as to be able to rotate around an axis, the rotating puck including through perforations which can be caused, by rotation around the axis, to overlap with the through perforations of the plate;
the apparatus may also comprise a control unit configured to drive:
   the enclosure suction pump,
   a neutral gas supply source for the enclosure,
   an electrical energy supply source for the electrodes,
   a lid movement motor;
the control unit can be configured to:
   during a pre-treatment phase:
      reduce the pressure inside the enclosed space to a value below atmospheric pressure,
      implement resistive heating of the mixture of raw materials,
      separate the lid from the edges of the upper opening,
   during a carboreduction phase:
      execute an initiation step composed of the sub-steps consisting of:
         increasing the pressure inside the enclosed space to a value substantially equal to atmospheric pressure,
         implementing electric arc heating of the mixture of raw materials,
         contacting the lid with the edges of the upper opening,
      then when the temperature of the mixture is greater than 2000° C., carry out a treatment step consisting of:
         maintaining the pressure inside the enclosed space at a value substantially equal to atmospheric pressure,
         maintaining electric arc heating of the mixture of raw materials,
         half opening the lid,
   during a post-treatment phase:
      reduce the pressure inside the enclosed space to a value below atmospheric pressure,
      separate the lid from the edges of the upper opening;
the sealed enclosure may comprise:
   a floor,
   a ceiling extending parallel to the floor, and
   at least one side partition extending between the floor and the ceiling;
the lid may comprise interface elements made of an electrically insulating material:
   at least one interface element being positioned between the cover tray and an electrode of the set of electrodes,
   at least one interface element being positioned between the cover tray and the tank.

The invention also relates to a process for producing silicon from quartz using an apparatus as defined above, remarkable in that the process comprises the following phases:
a pre-treatment phase including the steps consisting of:
   reducing the pressure inside the enclosed space to a value below atmospheric pressure,
   implementing resistive heating of the mixture of raw materials,
   separating the lid from the edges of the upper opening,
a carboreduction phase including:
   an initiation step composed of sub-steps consisting of:
      increasing the pressure inside the enclosed space to a value substantially equal to atmospheric pressure,
      implementing electric arc heating of the mixture of raw materials,
      contacting the lid with the edges of the upper opening,
   then when the temperature of the mixture is greater than 1500° C., a treatment step composed of sub-steps consisting of:
      maintaining the pressure inside the enclosed space at the value substantially equal to atmospheric pressure,
      maintaining electric arc heating of the mixture of raw materials,
      half opening the lid,
a post-treatment phase including the steps consisting of:
   reducing the pressure inside the enclosed space,
separating the lid from the edges of the upper opening.

### BRIEF DESCRIPTION OF THE DRAWINGS

Other advantages and features of the device and the process for producing silicon according to the invention will emerge better from the description which follows of several variants of execution, given by way of non-limiting examples, from the appended drawings in which:

FIG. 1 is a schematic representation of a silicon production device of the prior art,

FIG. 2 is a block diagram of the silicon production device according to the invention,

FIG. 3 is a schematic representation of a first embodiment of the silicon production device according to the invention,

FIG. 4 is a schematic representation of a second embodiment of the silicon production device according to the invention,

FIG. 5 is a schematic representation of a third embodiment of the silicon production device according to the invention

FIG. 6 is a schematic representation of a tank of the silicon production device according to the invention,

FIG. 7 is a partial schematic representation of an electric arc furnace,

FIG. 8 is a schematic representation of a lid of the silicon production device according to the invention,

FIGS. 9a, 9b, and 9c are schematic representations in top view of a lid according to the invention,

FIG. 10 is a schematic representation of different phases of a silicon production process according to the invention.

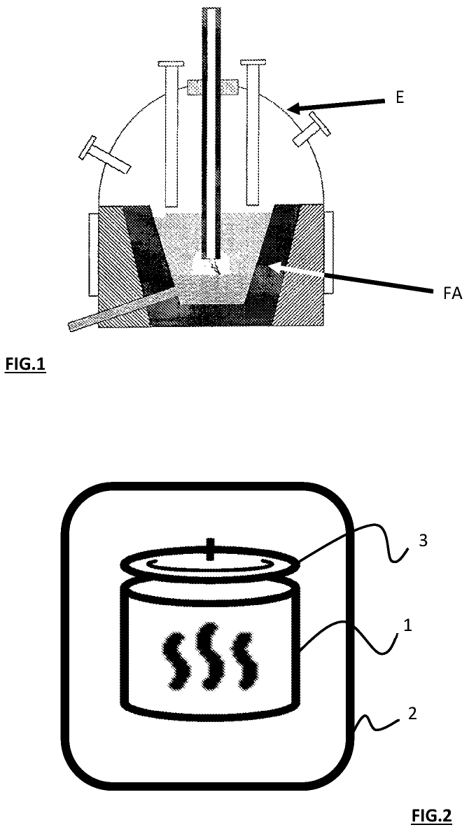

### DETAILED DESCRIPTION OF THE INVENTION

Different exemplary of embodiments of the invention will now be described with reference to the figures. In these different figures, the equivalent elements are designated by the same numerical reference.

### 1. GENERALITIES

With reference to FIG. 2, the apparatus according to the invention comprises:
an electric arc furnace 1,
a sealed enclosure 2, and
a lid 3 adapted to cover a tank 11 of the electric arc furnace 1, the arc furnace 1 and the lid 3 being housed in the enclosure 2.

### 2. PRESENTATION OF THE COMPONENTS OF THE APPARATUS ACCORDING TO THE INVENTION

### 2.1. Arc Furnace

The arc furnace 1 allows:
on the one hand, to contain the reagents—namely quartz and reducing agents—for the production of metallurgical grade silicon, and
on the other hand, to heat said reagents to a high temperature to induce the carbothermic reduction reaction of the quartz.

The arc furnace 1 is of a type known to the person skilled in the art, and its operation will not be described in detail below. It comprises in particular the tank 11 and electrodes 12.

### 2.1.1. Tank

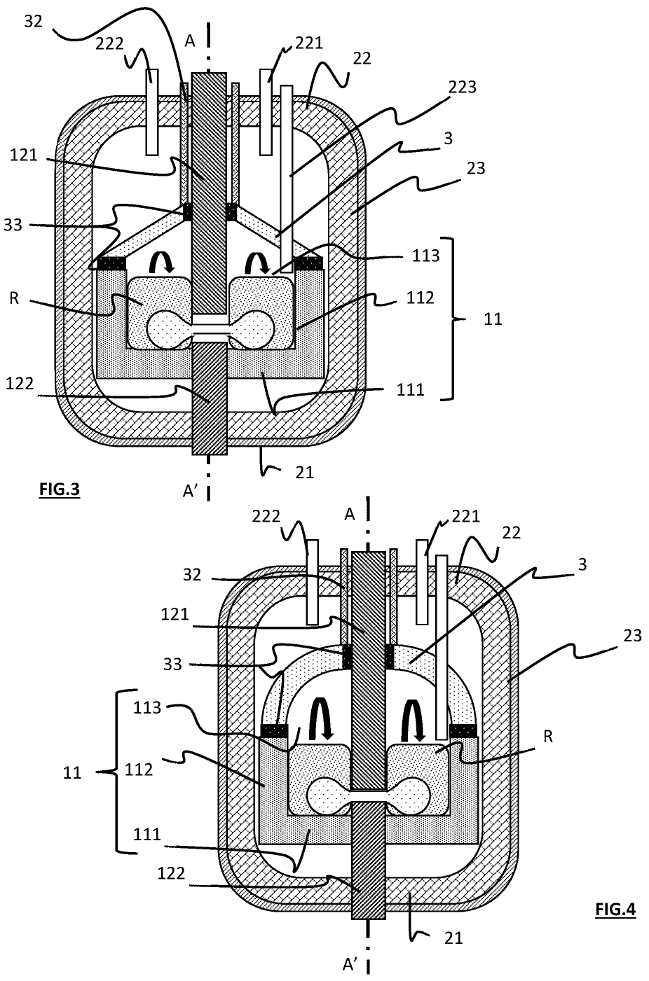

As illustrated in FIGS. 3 to 5, the tank 11 can consist of a graphite carcass externally coated with a refractory lining. Alternatively, the tank 11 can be made of silica, metal or silicon carbide (SIC).

The tank 11 (or crucible) is intended to contain the reagents, but also the liquid silicon resulting from the carbothermic reduction reaction of quartz.

The tank includes a bottom 111, one (or more) side wall(s) 112, and an upper opening 113. A longitudinal central axis of the apparatus which is vertical when the apparatus is placed on a flat horizontal surface is denoted A-A′. A side wall of the arc furnace 1 is substantially centered on the axis A-A′.

In the following, the description is oriented by considering that the terms “upper” and “top” correspond to a direction generally parallel to the axis A-A′ and going from the bottom 111 towards the opening 113, while the terms “lower” and “low” correspond to an opposite direction.

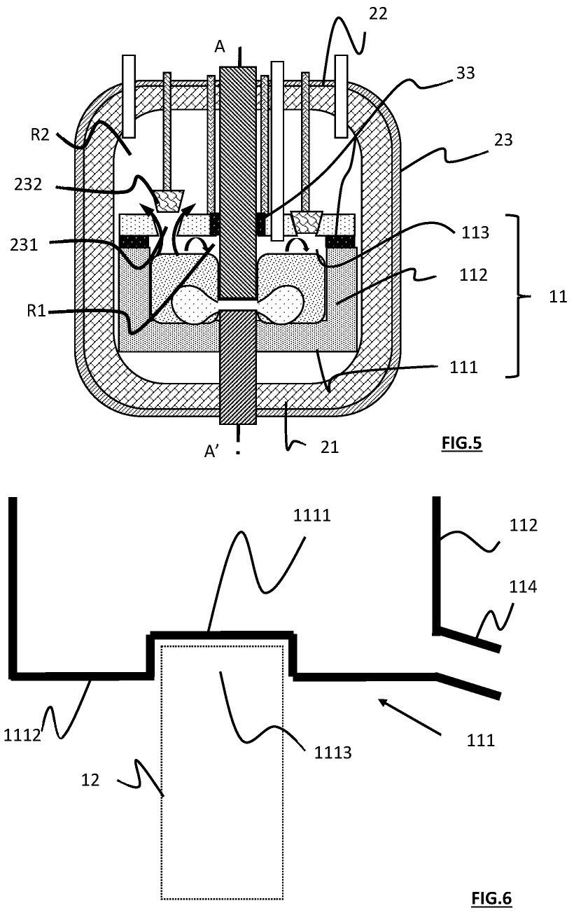

With reference to FIG. 6, the bottom 111 of the tank 11 may comprise a stud 1111 projecting towards the interior of the tank 11. More specifically, the stud 1111 projects from the bottom 111 and extends along the axis A-A′. The stud 1111 can be made of an electrically conductive material and constitute one of the electrodes 12.

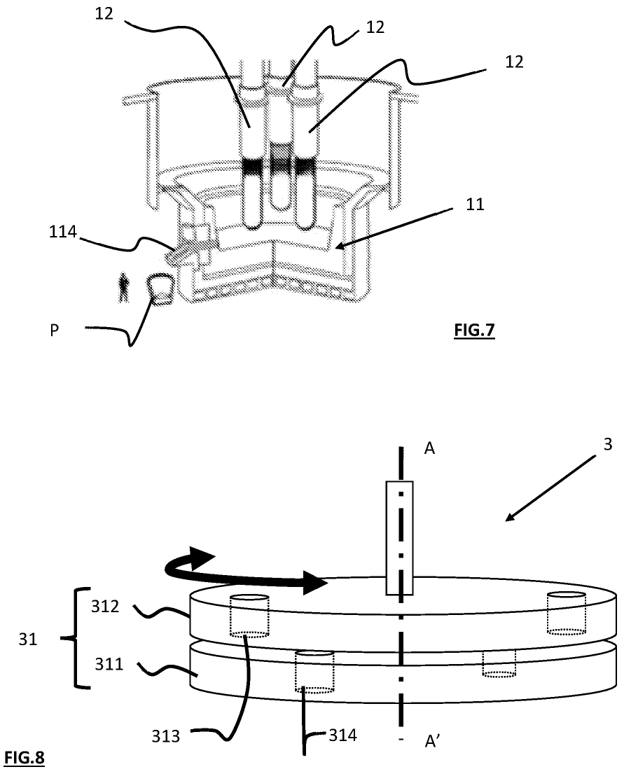

Alternatively, the bottom 111 may be devoid of stud and comprise only a circular recess 1113 through which one of the electrodes 12 is mounted. As a further variant, the bottom 111 of the tank 11 may be devoid of stud and circular recess 1113, particularly in the case where the electrode(s) of the arc furnace is (are) mounted above the tank 11, as illustrated in FIG. 7.

In certain alternative embodiments, the tank 11 may comprise a cooling system (not shown) in its upper part. This cooling system is for example composed of one (or more) panel(s) in which a heat transfer fluid circulates. In this case, the panel(s) is (are) mounted on an upper edge of the side wall(s) 112. The integration of a cooling system to the tank 11 allows to specifically control the temperature in the arc furnace 1 in order to vertically create a temperature gradient, in particular with a view to increasing the amount of reagent consumed during the carbothermic reduction reaction of quartz, and thus to improve the reaction yield.

In other alternative embodiments, the tank 11 is devoid of a cooling system.

The tank 11 also includes a casting channel (or several casting channels) 114 for evacuating the metallurgical grade silicon produced (in the liquid state) towards a casting ladle P intended to receive it for its subsequent storage.

A shutter system—such as a valve or a nozzle or a plug made of carbon material—can be provided for closing the casting channel(s) 114 during the carbothermic reduction reaction of the quartz.

At the time of casting, the tank 11, which can be mounted for example on a tilting cradle, is inclined towards the casting ladle so as to gradually send the metallurgical grade silicon in the liquid state through the casting channel(s). The casting channel(s) then being open, the liquid metallurgical grade silicon can then flow out of the tank and be collected in the casting ladle.

Of course, other configurations are possible to allow the extraction of metallurgical grade silicon. For example, the bottom of the container may have a non-zero slope in the direction of the casting channel(s) so as to send the metallurgical grade silicon towards the casting ladle when the shutter system is removed from the channel (method known as “tapping”).

### 2.1.2. Electrodes

For the formation of the electric arc allowing the heating of the reagents (quartz and reducing agent), the arc furnace 1 comprises electrodes 12 powered either from a direct current source or from an alternating current source.

Preferably, the electrodes 12 are placed in the axis of the arc furnace 1 so as to be stressed in a relatively symmetrical manner. More specifically, each electrode 12 may consist of a cylindrical bar made of graphite extending vertically.

In the embodiment illustrated in FIGS. 3 to 5, the arc furnace 1 comprises:
one (or more) movable electrode(s) 121 held by one (or more) support(s) not shown, the (or each) movable electrode 121 being able to be introduced into the arc furnace 1 passing (each) through a hole in the lid 3,
one (or more) fixed electrode(s) 122 housed in the bottom 111 of the tank 11.

The support(s) holding the movable electrode(s) allow(s) to vary the distance between the ends of the fixed and movable electrodes to control the amount of energy transferred to the liquid silicon.

As indicated previously, each electrode 121, 122 is connected to a direct current source or to an alternating current source. One of the advantages of a direct current supply is that the electrodes are not subject to the electromagnetic effects that the electrodes of a furnace powered from an alternating current source experience.

In the case of a direct current supply:
the movable electrode(s) 121 can be connected to the positive pole of the direct current source to form an anode,
the fixed electrode(s) can be connected to the negative pole of the direct current source and form a cathode.

### 2.2. Enclosure

The sealed enclosure 2 allows to define a enclosed space in which it is possible to generate a depression, that is to say a space in which it is possible to reduce the pressure to a value lower than atmospheric pressure.

Such an enclosure can have different shapes and be made from different materials to ensure this function.

Thus, in the context of the present invention, the term “sealed enclosure” means a box composed of at least one wall on either side of which there is a pressure difference. Thus, the sealed enclosure allows to delimit two areas (that is to say an internal area and an external area) between which there is a pressure difference.

In the embodiments illustrated in FIGS. 3 to 5, the sealed enclosure 2 has a cylindrical shape, and is essentially made up of steel walls.

This sealed enclosure 2 comprises:
a horizontal floor 21,
a horizontal ceiling 22, and
one (or more) vertical side partition(s) 23 extending between the floor 21 and the ceiling 22.

The (or one of the) side partition(s) 23 may comprise an access (pierced not shown) to allow an operator to access the interior of the enclosure 2. In operation, this access is shut by a door normally locked in a sealed manner by any technique known to the person skilled in the art, for example by bolting the door to said side wall, a seal (for example made of rubber) being mounted between the peripheral edges of the access and the facing door (that is to say between the edges of the access and the edges of the door facing each other).

The sealed enclosure 2 also comprises one (or more) through orifice(s), optionally for the passage:
of one (or more) gas injection channel(s) 221 into the enclosure 2, each channel being able to be connected to a gas supply source (such as argon),
of one (or more) gas suction channel(s) 222 contained in the enclosure 2, each channel can be connected to a suction pump to allow the generation of a depression inside the enclosure 2,
of one (or more) electrode(s) 121, 122,
of one (or more) conduit(s) 223 for supplying the arc furnace 1 with reagents R (quartz, reducing agents, etc.).
of electrical connection means (such as an electrically conductive cable, for example for the electrical connection of a sensor contained in the enclosure, etc.),
of one (or more) shaft(s) 32 for supporting the lid 3.

When the enclosure 2 comprises several orifices, the latter can be provided in just one of these walls or in several separate walls.

### 2.3. Lid

The lid 3 is configured to cover the upper opening 113 of the tank 11.

The lid 3 allows to contain the gases, and in particular the gas compound of silicon oxide (SiO)—formed during the carboreduction reaction of quartz inside the tank 11 of the arc furnace 1. This allows to limit the risks of clogging the enclosure 2, in particular at its partitions 21, 22, 23 and the suction channel(s) 222.

Moreover, the lid 3 allows to maintain the arc furnace 1 at a temperature (and more specifically at a temperature gradient) favoring the consumption of the reagents. This increases the reaction rate of the device, in particular with respect to the silicon production device described in U.S. Pat. No. 11,267,714.

The lid 3 comprises a cover tray 31, one (or more) support shafts 32.

The cover tray 31 can have different shapes. For example, the cover tray 31 may have a frustoconical shape (FIG. 3), a dome shape (FIG. 4), or a disc shape (FIG. 5). The cover tray 31 can be made of any type of refractory thermal insulation material known to the person skilled in the art, such as graphite.

Advantageously, the lid 3 is movable. More specifically, the lid 3 can be moved between:
a closed position in which the cover tray 31 completely covers the upper opening 113 of the tank 11 (the edges of the lid 3 being in contact with the edges of the upper opening 113 in the closed position), and
an open position in which the cover tray 31 does not cover (or partially covers) the upper opening 113 of the tank 11.

For this purpose, the support shaft(s) 32 of the lid 3 can be connected to one (or more) motor(s).

The fact that the lid 3 is movable allows access to the interior of the tank of the arc furnace 1, for example:
for maintenance operations on the arc furnace 1, and/or
for loading/reloading the interior of the tank 11 with reagents necessary for the carboreduction reaction, and/or
for promoting the evacuation of certain gases produced during the carboreduction reaction, etc.

In the embodiments illustrated in FIGS. 3 to 5, the cover tray 31 of the lid 3 comprises recesses for the passage:
of one (or more) of the electrode(s) 121,
of the conduit(s) 223 for supplying the arc furnace 1 with reagents R.

Preferably, the lid 3 is electrically (and optionally thermally) insulated from the other components of the device.

In particular, in the embodiments illustrated in FIGS. 3 to 5, the lid 3 is electrically insulated:
from the electrode 121 (or the electrodes 121) extending above the upper opening 113 of the tank 11,
from the tank 11 on which it is configured to rest (this allows to electrically insulate the lid of the electrode 122 disposed under the bottom 111 of the tank 11), and
from the supply conduit(s) 223 (this allows to limit the risk of electrocution of an operator located outside the device).

For this purpose, the lid 3 comprises interface elements 33 made of an electrically (and optionally thermally) insulating material, such as zirconia or any other material known to the person skilled in the art.

Advantageously, the lid 3 can also comprise one (or more) through lumen(s) 231 able to be blocked by one (or more) movable shutter component(s) 232. These through lumens 231 form exhaust conduits for the gases confined in a region R1 defined between the tank 11 and the cover tray 31 when the lid 3 is in the closed position. The component(s) can be moved between:
a released position in which the through lumen(s) is (are) unblocked to allow the circulation of fluids (in particular gases) between the region R1 and a region R2 outside the region R1 defined between the tank 11 and the cover tray 31,
a shut position in which the through lumen(s) is (are) blocked to confine the fluids in the region R1 defined between the tank 11 and the cover tray 31.

Of course different configurations for producing the through lumens and the shutter components can be considered.

For example, in the embodiment illustrated in FIG. 5 the cover tray 31 is made up of a single graphite plate in which frustoconical vents—forming through lumens 231—are provided. Plugs—forming a shutter component 232—of a shape complementary to the frustoconical vents are provided in line with the vents, each plug being associated with a respective vent and being suspended from a rod to allow its movement in translation between the released and shut positions.

Alternatively, in the embodiment illustrated in FIG. 8, the cover tray 31 is of the rotary closure type. In particular, the cover tray 31 comprises a plate 311 including cylindrical perforations 313 forming through lumens. The plate 311 is intended to rest on the edges of the upper opening 113.

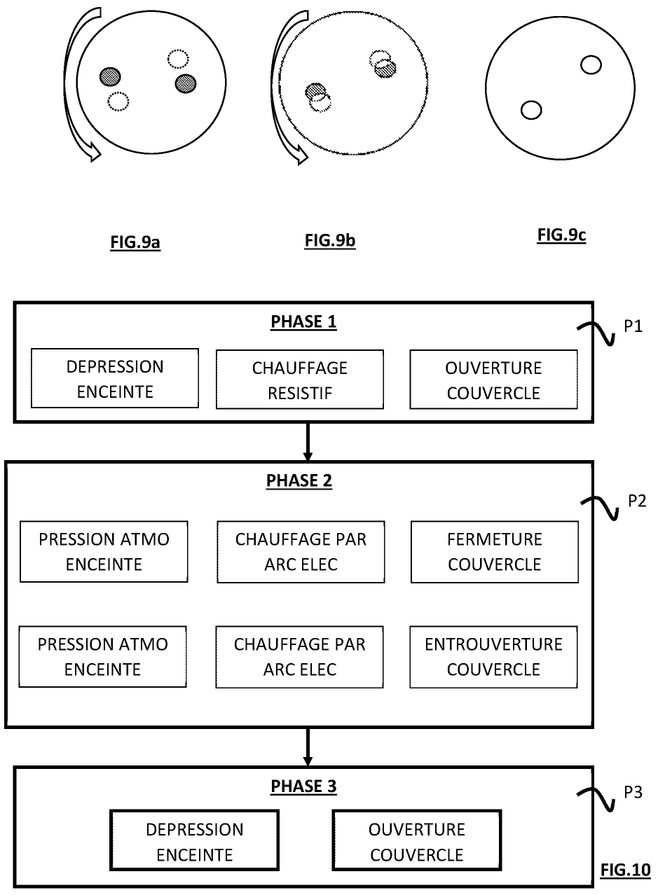

The cover tray 31 also comprises a rotating puck 312 configured to rest on the plate 311 so as to be able to rotate on itself around the longitudinal central axis A-A′. The rotating puck 312 also comprises through perforations 314 which can be caused to overlap, through relative rotations, with the through perforations 313 of the plate 311:
when the through perforations 313, 414 overlap (see FIG. 9c), they define a passage for the evacuation of gases and heat contained in region R1,
when the through perforations 313, 314 do not overlap (see FIG. 9a), the gases and heat contained in region R1 are blocked therein.

Thus, the rotating puck 312 including through perforations forms the shutter component.

### 3. OPERATING PRINCIPLE

The operating principle of the apparatus according to the invention will now be described with reference to FIG. 10 representing the main steps of a process for producing silicon from quartz. These steps can be carried out by a control unit allowing to drive the components of the apparatus described in point 2 above.

### 3.1. Control Unit

The control unit is for example one or more computer(s), one or more processor(s), one or more microcontroller(s), one or more microcomputer(s), one or more programmable controller(s), one or more application specific integrated circuit(s), other programmable circuits, or other devices that include a computer such as a workstation.

The control unit comprises one (or more) memory(ies) which may be ROM/RAM memory, a CD-ROM, a USB key, a central server memory. This (or these) memory(ies) allow(s) to store program code instructions for the execution of the process illustrated in FIG. 10.

### 3.2. Silicon Production Process

It is assumed that a mixture of raw materials containing, for example, quartz, and a reducing agent, typically carbon, was previously positioned in the tank 11.

### 3.2.1. Pre-Treatment Phase

A pre-treatment phase allowing the initiation of the carboreduction reaction as well as the removal of impurities from the mixture of raw materials is implemented. This pre-treatment phase comprises the steps:
of generating a depression in the sealed enclosure 2,
of resistive heating (thanks to the energy transferred by the electrodes 12) the mixture of raw materials contained in the tank 11, and
of opening the lid 3.

To generate a depression, the control unit commands the activation of the suction pump(s) to suck up the gases contained in the enclosure 2. This allows to generate a pressure difference between internal area of the enclosure 2 and an external area of the enclosure 2.

For the resistive heating of the mixture, the control unit commands the movement of the movable electrode(s) so that the latter contact(s) the fixed electrode(s). The control unit also commands the activation of the (alternating or direct) current source connected to the electrodes to supply them with electrical energy. This electrical energy is converted into thermal energy by the electrodes. This allows to heat the mixture of raw materials to high temperature (typically comprised between 1000° C. and 1500° C.).

To open the lid, the control unit commands the activation of the motor(s) coupled to the support shaft(s) 32 to move the lid 3 to the open position.

During this pre-treatment phase, certain impurities are volatilized, those having a high vapor pressure. Generating a depression in the enclosure, and opening the lid while heating the raw materials allows impurities to escape out of the enclosure (said impurities being sucked up by the suction pump(s)).

### 3.2.2. Carboreduction Phase

Once this pre-treatment phase is completed (when the temperature in the enclosure reaches 1000° ° C. to 1500° C.), a carboreduction phase is implemented. This carboreduction phase comprises the steps:
of returning to atmospheric pressure in the sealed enclosure 2,
of closing the lid 3 and heating by electric arc the mixture contained in the arc furnace 1 up to a carboreduction temperature, and
of partially opening the lid 3 and maintaining the electric arc heating of the mixture.

To return to atmospheric pressure, the control unit commands the activation of the gas supply source(s) to inject a neutral gas (such as argon) into the enclosure 2. The control unit also commands the deactivation of the suction pump(s).

For electric arc heating of the mixture, the control unit commands the movement of the movable electrode(s) so as to move the latter away from the fixed electrode(s). The activation of the (alternating or direct) current source is maintained to allow the formation of an electric arc between the fixed and movable electrodes.

To close the lid 3, the control unit commands the activation of the motor(s) coupled to the support shaft(s) 32 to move the lid 3 to the closed position.

To partially open the lid 3, the control unit commands:
if the lid is devoid of through lumen and shutter component, the activation of the motor(s) coupled to the support shaft(s) 32 to move it to an intermediate position comprised between the open and closed positions,
if the lid comprises one (or more) through lumen(s) and one (or more) shutter component(s), the activation of the motor(s) associated with the shutter component(s) to move it into the released position.

Closing the lid 3 and generating an electric arc in the arc furnace allows to quickly increase the temperature of the mixture to 1500 to 2000° C.

Once the temperature has been reached, the fact of half-opening the lid 3 while maintaining electric arc heating allows heat dissipation of the upper part of the reaction medium: a temperature gradient is then created in the reaction medium (high temperature at the bottom of the tank 11 and lower temperature at the upper opening of the tank 11). The fact of forming a temperature gradient in the tank 11 of the arc furnace allows the formation of the different reaction intermediates in the different temperature areas as well as the exchanges between them for an efficient carboreduction reaction.

### 3.2.3. Post-Treatment Phase

At the end of the carboreduction reaction, when all the raw materials have reacted and liquid silicon is formed in the tank 2, the lid 3 is completely raised. The depression of the enclosure 2 is again carried out to allow the elimination of impurities present in the liquid silicon and which have a high vapor pressure such as phosphorus, and resistive type heating is again implemented.

The control unit commands the activation of the suction pump(s) to suck up the gases contained in enclosure 2 and generate depression in the enclosure 2.

The control unit also commands the activation of the motor(s) coupled to the lid 3 to move it to the open position.

The control unit finally commands:
moving the movable electrode(s) so that the latter contact(s) the fixed electrode(s)
activating the (alternating or direct) current source connected to the electrodes to supply them with electrical energy.

### 4. CONCLUSIONS

The integration of a lid 3 into a device according to the invention including an arc furnace and a sealed enclosure has numerous advantages compared to the apparatus according to U.S. Pat. No. 11,267,714.

In particular, the presence of a lid allows to increase the reaction rate of the raw materials of the mixture.

Indeed, in the process according to U.S. Pat. No. 11,267,714, the reaction area is not confined. However, as indicated previously, the carboreduction reaction involves several gas reaction intermediates. If these reaction intermediates are not confined to the same location, then the reaction is partial, which reduces the reaction yield.

Moreover, the fact of driving the opening and closing of the lid during the carboreduction reaction allows on the one hand better control of the temperature gradient inside the arc furnace tank, the regulation of the temperature gradient being an important element in the formation of the different reaction intermediates and their reactions with each other for the synthesis of Silicon.

The reader will have understood that numerous modifications can be made to the invention described above without materially departing from the new teachings and advantages described here.

1. An apparatus for producing silicon from quartz, the apparatus comprising:
a sealed enclosure defining an enclosed space, the enclosure being connected to at least one suction pump to generate a pressure difference between the interior and the exterior of the enclosed space, the pressure inside the enclosed space being lower than the pressure outside the enclosed space when the suction pump is activated,
an electric arc furnace housed inside the sealed enclosure, the arc furnace including:
a tank for containing a mixture of raw materials for the production of silicon,
a set of electrodes configured to form an electric arc for heating the mixture,
wherein the apparatus further comprises a movable lid housed in the enclosure, the lid being adapted to cover an upper opening of the tank.

2. The apparatus according to claim 1, wherein the lid comprises a cover tray, and at least one support shaft fixed to the cover tray, the movable lid being movable between:
a closed position in which the cover tray completely covers the upper opening of the tank, and
an open position in which the upper opening of the tank is at least partially uncovered.

3. The apparatus according to claim 2, wherein the cover tray comprises at least one through lumen and at least one associated shutter component, each shutter component being movable between:
a released position in which the through lumen is unblocked to allow the circulation of a gas between:
a first region defined between the tank and the cover tray, and
a second region external to the first region,
a shut position in which the through lumen is blocked to limit the circulation of gas between the first and second regions.

4. The apparatus according to claim 3, wherein:
each through lumen is composed of a frustoconical vent provided in the cover tray,
each associated shutter element is composed:
of a plug of complementary shape to the frustoconical vent and
of a suspension rod fixed to the plug to allow its movement in translation between the released and shut positions.

5. The apparatus according to claim 2, wherein the cover tray includes:
a plate including cylindrical perforations,
a rotating puck configured to rest on the plate so as to be able to rotate around an axis, the rotating puck-including through perforations which can be caused, by rotation around the axis, to overlap with the through perforations of the plate.

6. The apparatus according to claim 1, which further comprises a control unit configured to drive:
the suction pump of the enclosure,
a neutral gas supply source for the enclosure,
an electrical energy supply source for the electrodes,
a lid-movement motor.

7. The apparatus according to claim 6, wherein the control unit is configured to:
during a pre-treatment phase:
reduce the pressure inside the enclosed space to a value below atmospheric pressure,
implement resistive heating of the mixture of raw materials,
separate the lid from the edges of the upper opening,
during a carboreduction phase:
execute an initiation step composed of the sub-steps consisting of:
increasing the pressure inside the enclosed space to a value substantially equal to atmospheric pressure,
implementing electric arc heating of the mixture of raw materials,
contacting the lid with the edges of the upper opening,
then when the temperature of the mixture is greater than 2000° C., carry out a treatment step consisting of:
maintaining the pressure inside the enclosed space at the value substantially equal to atmospheric pressure,
maintaining electric arc heating of the mixture of raw materials,
half opening the lid,
during a post-treatment phase:
reduce the pressure inside the enclosed space to a value below atmospheric pressure,
separate the lid from the edges of the upper opening.

8. The apparatus according to claim 1, wherein the sealed enclosure comprises:
a floor,
a ceiling extending parallel to the floor, and
at least one side partition extending between the floor and the ceiling.

9. The apparatus according to claim 2, wherein the lid comprises interface elements made of an electrically insulating material:
at least one interface element being positioned between the cover tray and an electrode of the set of electrodes,
at least one interface element being positioned between the cover tray and the tank.

10. A method for producing silicon from quartz using an apparatus for producing silicon from quartz, the apparatus comprising:
a sealed enclosure defining an enclosed space, the enclosure being connected to at least one suction pump to generate a pressure difference between the interior and the exterior of the enclosed space, the pressure inside the enclosed space being lower than the pressure outside the enclosed space when the suction pump is activated,
an electric arc furnace housed inside the sealed enclosure, the arc furnace including:
a tank for containing a mixture of raw materials for the production of silicon,
a set of electrodes configured to form an electric arc for heating the mixture,
a movable lid housed in the enclosure, the lid being adapted to cover an upper opening of the tank,
wherein the method comprises the following phases:
a pre-treatment phase including the steps consisting of:
reducing the pressure inside the enclosed space to a value below atmospheric pressure,
implementing resistive heating of the mixture of raw materials,
separating the lid from the edges of the upper opening,
a carboreduction phase including:
an initiation step composed of sub-steps consisting of:
increasing the pressure inside the enclosed space to a value substantially equal to atmospheric pressure,
implementing electric arc heating of the mixture of raw materials,
contacting the lid with the edges of the upper opening,
then when the temperature of the mixture is greater than 1500° C., a treatment step composed of sub-steps consisting of:
maintaining the pressure inside the enclosed space at the value substantially equal to atmospheric pressure,
maintaining electric arc heating of the mixture of raw materials,
half opening the lid,
a post-treatment phase including the steps consisting of:
reducing the pressure inside the enclosed space,
separating the lid from the edges of the upper opening.

11. The method according to claim 10, wherein the lid comprises a cover tray, and at least one support shaft fixed to the cover tray, the movable lid being movable between:
a closed position in which the cover tray completely covers the upper opening of the tank, and
an open position in which the upper opening of the tank is at least partially uncovered.

12. The method according to claim 11, wherein the cover tray comprises at least one through lumen and at least one associated shutter component, each shutter component being movable between:
a released position in which the through lumen is unblocked to allow the circulation of a gas between:
a first region defined between the tank and the cover tray, and
a second region external to the first region,
a shut position in which the through lumen is blocked to limit the circulation of gas between the first and second regions.

13. The method according to claim 12, wherein:
each through lumen is composed of a frustoconical vent provided in the cover tray,
each associated shutter element is composed:
of a plug of complementary shape to the frustoconical vent and
of a suspension rod fixed to the plug to allow its movement in translation between the released and shut positions.

14. The method according to claim 11, wherein the cover tray includes:
a plate including cylindrical perforations,
a rotating puck configured to rest on the plate so as to be able to rotate around an axis, the rotating puck including through perforations which can be caused, by rotation around the axis, to overlap with the through perforations of the plate.

15. The method according to claim 10, wherein the apparatus further comprises a control unit configured to drive:
the suction pump of the enclosure,
a neutral gas supply source for the enclosure,
an electrical energy supply source for the electrodes,
a lid movement motor.

16. The method according to claim 15, wherein the control unit is configured to:
during a pre-treatment phase:
reduce the pressure inside the enclosed space to a value below atmospheric pressure,
implement resistive heating of the mixture of raw materials,
separate the lid from the edges of the upper opening,
during a carboreduction phase:
execute an initiation step composed of the sub-steps consisting of:
increasing the pressure inside the enclosed space to a value substantially equal to atmospheric pressure,
implementing electric arc heating of the mixture of raw materials,
contacting the lid with the edges of the upper opening,
then when the temperature of the mixture is greater than 2000° C., carry out a treatment step consisting of:
maintaining the pressure inside the enclosed space at the value substantially equal to atmospheric pressure,
maintaining electric arc heating of the mixture of raw materials,
half opening the lid,
during a post-treatment phase:
reduce the pressure inside the enclosed space to a value below atmospheric pressure,
separate the lid from the edges of the upper opening.

17. The method according to claim 10, wherein the sealed enclosure comprises:
a floor,
a ceiling extending parallel to the floor, and
at least one side partition extending between the floor and the ceiling.

18. The method according to claim 11, wherein the lid comprises interface elements made of an electrically insulating material:
at least one interface element being positioned between the cover tray and an electrode of the set of electrodes,
at least one interface element being positioned between the cover tray and the tank.
